(19) United States
(12) Patent Application Publication
(10) Pub. No.: US 2007/0115663 A1
(43) Pub. Date: May 24, 2007

(54) Twirler novelty

(76) Inventors: Margaret Weiser, Tarzana, CA (US); Isaac Weiser, Tarzana, CA (US)

Correspondence Address: CISLO & THOMAS, LLP, 233 WILSHIRE BLVD, SUITE 900, SANTA MONICA, CA, 90401-1211, US

(21) Appl. No.: 11/286,868

(22) Filed: Nov. 23, 2005

(51) Int. Cl. F21V 33/00

(52) U.S. Cl. 362/253

(57) ABSTRACT

A rotating sculpture that is rotated about a central axis by air currents acting on wind cups located on arms that extend from the central axis. One or more decorative elements may be attached to the sculpture. One or more illuminative elements, chosen from a group consisting of household electricity powered light, battery powered electric light, solar powered electric light, wind-generated electric light, prismatic lenses, or reflective surfaces, may be attached to the sculpture.

### BACKGROUND

Various decorative kinetic sculptures have been developed in prior art to afford a pleasing visual appearance when set in motion by the wind. Many of these designs are made of angled surfaces that catch the wind and rotate some or all of the sculpture. Still other sculptures employ solar powered lights to enhance their appearance in the evening hours. One of the benefits of these sculptures is that their motion and/or light can deter animals from eating garden plants. While these prior art sculptures have been useful, there still remains a need for an improved rotating sculpture.

### SUMMARY

Various embodiments disclosed herein are directed to a rotating sculpture. According to one embodiment, the rotating sculpture is composed of a support element, from which the device hangs or is mounted, and rotatably attached to which is a central element, attached to which is a set of arms that extend from and encircle the central element and may be joined at an end distal from the support element. The arms may be equipped with wind cups, oriented in such manner to catch the breeze and rotate the device. In one embodiment, the central element may extend away from the support element, and may hold a decorative element. An illuminative element may also be included anywhere on the rotating sculpture, including inside the decorative element. The illuminative element may be illuminated by household electricity, battery power, solar power, wind power, prismatic lenses, or reflective elements.

### BRIEF DESCRIPTION OF THE DRAWINGS

FIG. 1 is a top perspective view an embodiment of our TWIRLER NOVELTY;

FIG. 2 is a side view thereof;

FIG. 3 is a side view thereof rotated 180 degrees from FIG. 2;

FIG. 4 is a side view thereof rotated 90 degrees from FIG. 3;

FIG. 5 is a side view thereof rotated 180 degrees from FIG. 4;

FIG. 6 is a top plan view;

FIG. 7 is a bottom plan view; and

FIG. 8 is a detailed cut-away side view of the rotational mechanism.

FIG. 9 is a side view of an alternative embodiment using a base.

### DETAILED DESCRIPTION

The detailed description set forth below in connection with the appended drawings is intended as a description of exemplary embodiments and is not intended to represent the only forms in which the embodiments may be constructed and/or utilized. However, it is to be understood that the same or equivalent functions and sequences may be accomplished by different embodiments that are also intended to be encompassed within the spirit and scope of the specification.

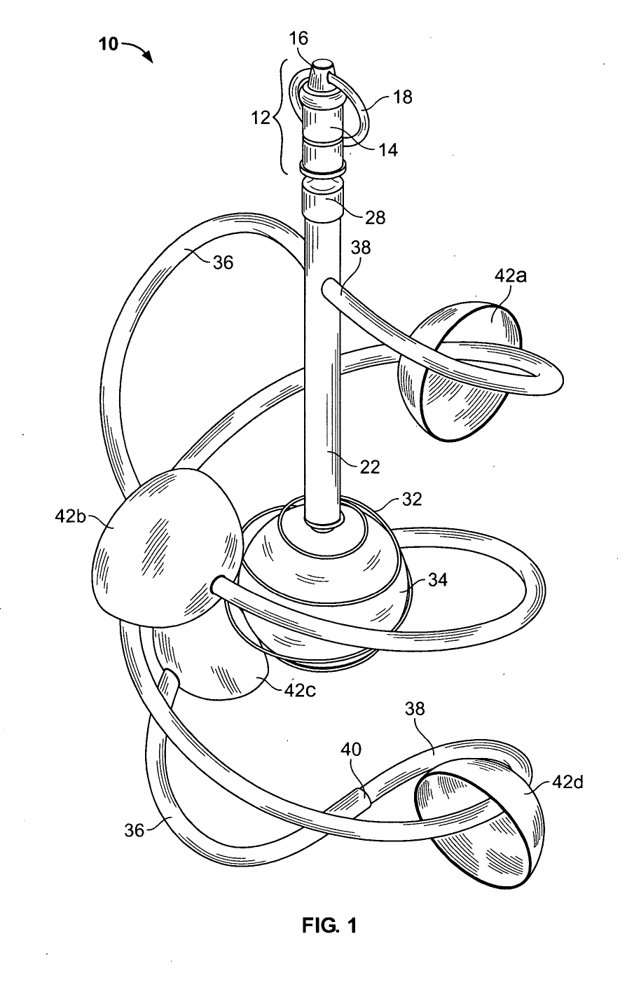

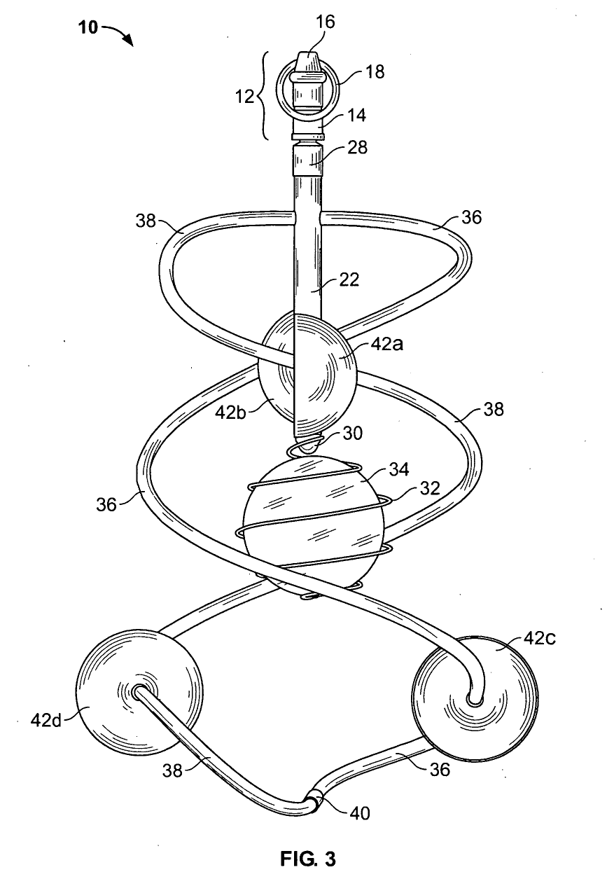

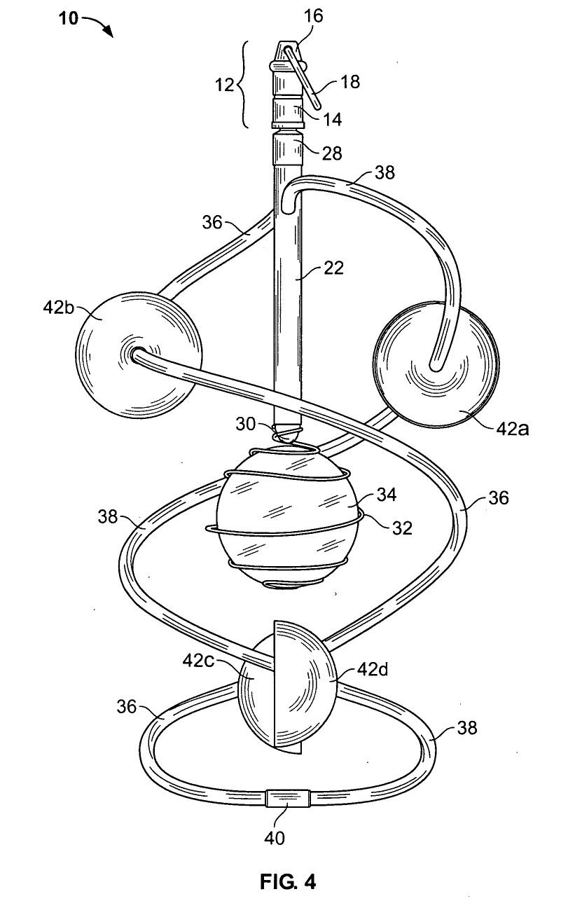

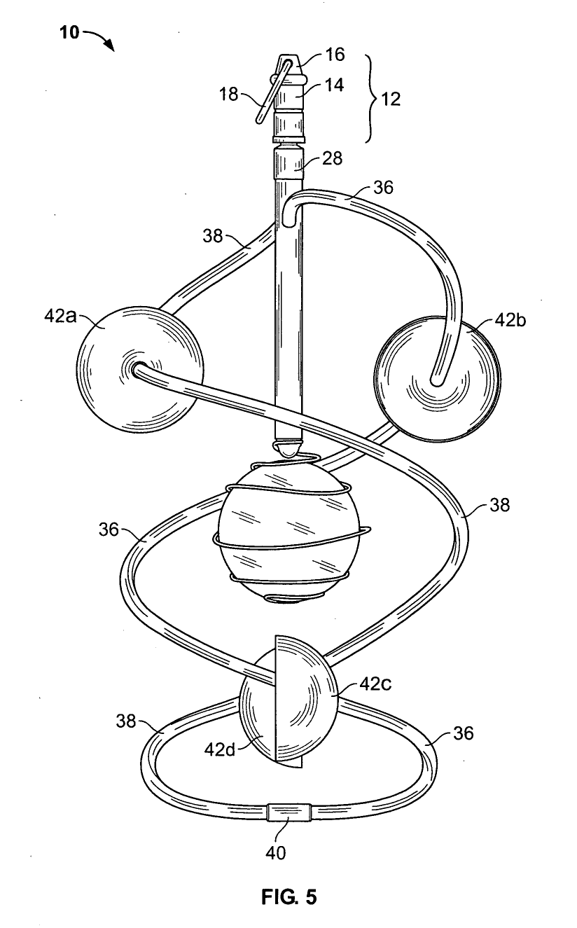

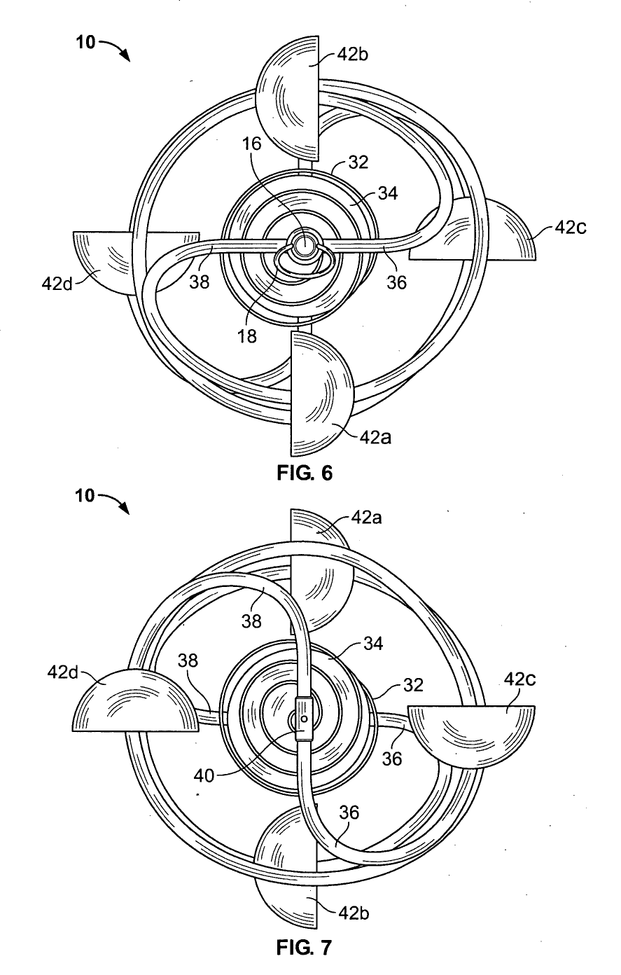

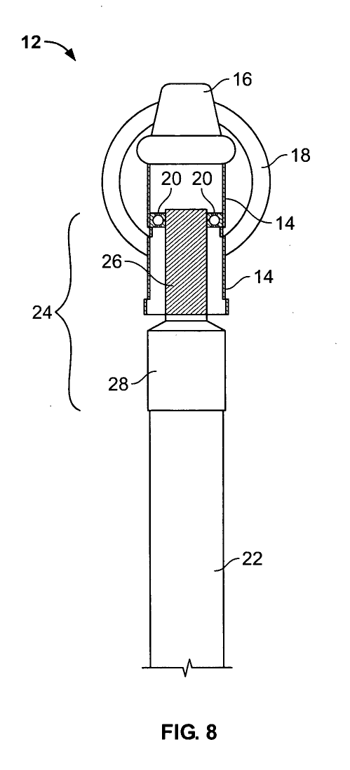

Turning now to the Figures, FIG. 1 shows one exemplary embodiment of a rotating sculpture 10. The rotating sculpture 10 may be primarily constructed of cylindrical tubing, although any suitable materials could be used. As shown in FIGS. 1-7, the support element 12 is comprised of a rotatable coupling cylinder 14, with a top piece 16 affixed for holding a ring 18 or other suitable element for hanging the rotating sculpture 10. As shown in FIG. 8, within the rotatable coupling cylinder 14 is a rotatable coupling 20, which in a preferred embodiment is a thrust bearing using ball bearings, although any suitable bearing could be used. Preferably, such bearings have low torque requirements and are maintenance free in outdoor environments. As will be appreciated by those skilled in the art, both such features are widely available in commercial bearing products in a variety of materials and configurations. Such features will assure that, the rotating sculpture will continue to function in any environment without the need for user maintenance. Moreover, the rotatable coupling cylinder 14 and top piece 16, if sealed together, should protect the rotatable coupling 20 from water intrusion.

The rotatable coupling is coupled with a central element 22, which in a preferred embodiment comprises a rotatable coupling fitting 24 with a first end 26 that engages with the rotatable coupling and a second end 28 that flares out to mate with a first end of a cylindrical tube, with the second end of the cylindrical tube having a decorative element fitting 30 to attach a decorative element. In a preferred embodiment, the first end of the rotatable coupling fitting may be coupled with the rotatable coupling by using a “press fit” between the beaming and the first end, although as those skilled in the art will appreciate any suitable coupling method could be used. A decorative element fitting 30 is a threaded fitting that is pressed, welded, formed, glued or otherwise attached to the end of the tubing. In one embodiment, a decorative element retainer 32 whose surface may be decorative, prismatic, etc. may be held in place at the end of the central element by forming a loop at one end of a wire, inserting a screw in the loop and screwing it into the threaded decorative element fitting 30. The remaining wire may then be bent into the decorative element retainer 32, which in one embodiment is spiral shaped to hold the decorative element 34 in place. Other embodiments may use other fittings or decorative element retainers, the latter including but not limited to cast, molded, or formed cages or other retention devices known in the art. The decorative element 32 may include an illuminating element, not shown, which may be solar, battery or power source energized.

In a preferred embodiment, two arms 36, 38 are then coupled with the central element 22, located on opposite sides of the central element 22 and protruding at 90 degree angles from its long axis. The arms 36, 38 are then shaped into a spiral with a relatively constant radius whose center generally corresponds to the long axis of the central element 22, and the arms 36, 38 are further shaped such that the arms spiral away from the support element 12, as shown in FIGS. 1-7. The arms 36, 38 have substantially the same shape, but given their mounting locations on the central element 22 at approximately 180 degrees from each other, the spirals are 180 degrees out of phase, complementing each other rather than crossing or touching at any point. At a point distal to the support element 12 and beyond the decorative element 34, the spiral of the arms may tighten and the arms may meet, and may be coupled together by conventional means, such as a sleeve 40 placed into or outside of each arm and welded, brazed, glued, melted, screwed, or any other suitable method. Alternatively, the two arms 36, 38 could be fashioned from a single piece of tubing or other suitable material, so that no such coupling of the arms is required.

In other embodiments, there may be a different number of arms, ranging from one to as many as desired, and the mounting locations and angles may be varied to suit the application. In such embodiments the spirals may have differing radii, opposite rotations, and may cross or connect at any point. In other embodiments the arms need not be spiral, but could be in any configuration suitable to mount the wind cups 42, as discussed below. In other embodiments using more than one arm, the arms need not meet or be coupled together.

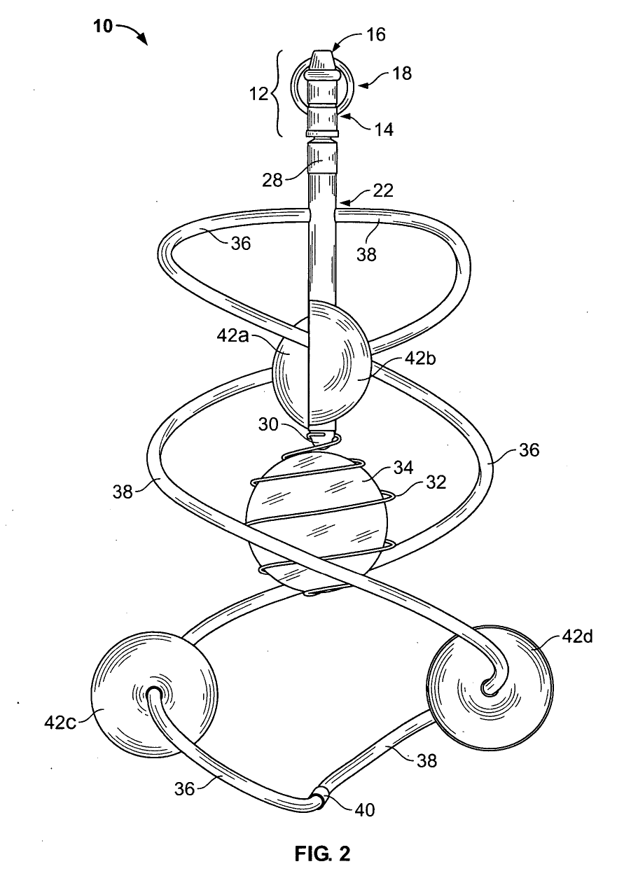

Wind cups 42 (42a, 42b, 42c, 42d) may be coupled with the one or more arms 36, 38 in such orientations that they catch air currents and exert force on the arm 36 on 38 with which they are coupled, which causes the central element 22 with which said arm 36 or 38 is coupled to rotate about its long axis via the rotatable coupling 20. In a preferred embodiment as shown in FIGS. 1-7, a wind cup 42 may be a hollow hemisphere coupled with an arm 36 on 38 via a hole in the center of the hemisphere. In other embodiments the wind cups 42 may be different shapes, but preferably are shaped such that a first orientation will effectively catch air currents while a second orientation that is approximately 180 degrees from the first orientation will have substantially reduced effectiveness in catching air currents. In a preferred embodiment the hemisphere is slid onto the arm and affixed in a orientation such that the straight edge of the hemisphere is roughly at a right angle to a radius drawn from the long axis of the central element. See, for example, FIG. 2, with wind cup 42b affixed to arm 36. In other embodiments different wind cup orientations as attachment methods may be used, any such orientation should be placed to make effective use of air currents to rotate the sculpture 10 and not counteract the forces produced by the other wind cups 42. In order to effectively rotate the sculpture 10, at least two wind cups 42 should be used, located on opposite sides. The sculpture 10 will make more effective use of the air currents if additional wind cups 42 are used. A preferred embodiment shown in FIGS. 1-7 shows the use of four wind cups 42, but other embodiments could use more or less wind cups. Other embodiments may also place the wind cups 42 in locations different from those shown in FIGS. 1-7.

The decorative element 34 of one embodiment as shown in FIGS. 1-7 is a glass ball, but any decorative element could be used, of any shape, size or configuration. Other embodiments may use a different decorative element(s) 34, additional decorative elements, and different placement of such decorative element(s). For example, one or more decorative elements 34 may be placed on one or more arms 36 or 38, or at different location(s) on the central element 22 or even the top piece 16.

As part of, or in conjunction with, a decorative element 34, having a transparent or opaque character, an illuminative element 44 is placed within, the decorative element 34. Obviously, a light emitting element may be placed elsewhere or at any location on the rotating sculpture. In one embodiment, an illuminative element 44 is a solar powered electric light, converting sunlight to electricity with a photovoltaic panel and storing it in a battery, then using a photocell to turn a light emitting device, such as a lightbulb or LED, when it is dark enough to be seen. Such an embodiment would allow the user to enjoy the rotating sculpture 10 both during the day and at night. As for light emitting devices, LEDs have a power consumption advantage over regular incandescent lightbulbs, but any light emitting device that is suitable for the type and amount of available power may be employed. More than one light emitting device may be used, and as those skilled in the art will appreciate, multiple light emitting devices may be placed at various locations on or around the rotating sculpture 10.

Another embodiment of the illuminative element 44 may use wind generated electricity. A shaft may be attached to the top piece and run through the rotatable coupling, down the center of the central element, and coupled with the stator of a generator. The exterior of the central element 22 turns when the wind cups 42 catch wind currents and rotate the sculpture 10, and the rotating portion of the generator may therefore be coupled either directly to the central element 22, or to a geared multiplier that increases the rotational speed of the central element 22 and applies that increased rotation to the generator. The generated electricity may either be transmitted to a battery, or directly to a light emitting device to produce light, or both, depending on the amount of electricity produced and whether the light is being operated. As with the solar powered light, a photocell may be used to turn the light on when it is sufficiently dark to see it. Another embodiment may use both solar and wind generated electricity to power the light emitting devices.

In another embodiment, standard charged (disposable) or rechargeable batteries may be used to supply the electricity to the illuminative element 44. An arrangement that would yield long life with little maintenance would be a lithium battery coupled with one or more LEDs, turned on and off by either a photocell, a microcontroller with a timer, or both. A manual or remote controlled switch may also be used. Battery technology is rapidly advancing, and certain silicon-based batteries using a porous silicon diode have shown promise to be even longer lived than lithium. Thus it is anticipated that this embodiment may use any available suitable battery. As with the other illuminative element 44 embodiments, any combination of light emitting devices, batteries, and control devices that are suitable for the application may be used.

In yet another embodiment, the illuminative element 44 may use household electricity as its power source. Wires may be run through support element 12 and through the rotatable coupling fitting 24 and into the central element 22 to the illuminative element 44. Any suitable voltage or wattage may be used to power the light emitting device(s).

In another embodiment, the illuminative element 44 may consist of prismatic lenses, reflective elements, or both. Prismatic lenses can act both as color generators and reflective surfaces, and can be used in a wide variety of shapes, such as traditional three-sided prisms, polygonal crystals, or any desired shape. Reflective surfaces such as mirrors or polished metals can be used in any combination and in any arrangement to generate reflected light from the sculpture. Such reflective surfaces are typically more efficient at reflecting light, but their color generating capabilities are typically less efficient, and thus a combination of reflective surfaces and prismatic lenses may be used to generate a larger amount of colors and reflected light than either alone. In addition, reflective surfaces may be used to direct light into the prismatic lenses. Whether using the prismatic lenses or reflective elements or both, they can either be fixed to rotate with the sculpture 10, or suspended so they sway and have a slightly different rotation speed than the sculpture 10. The suspending elements could also be mounted on simple bearings to help the prismatic lenses or reflective elements achieve a different rotational speed, or they could be fixed to a central shaft that remains stationary relative to the rotating sculpture.

In yet another embodiment, the rotating sculpture 10 could employ any combination of the above-described illuminative elements 44 to achieve the desired look of the sculpture.

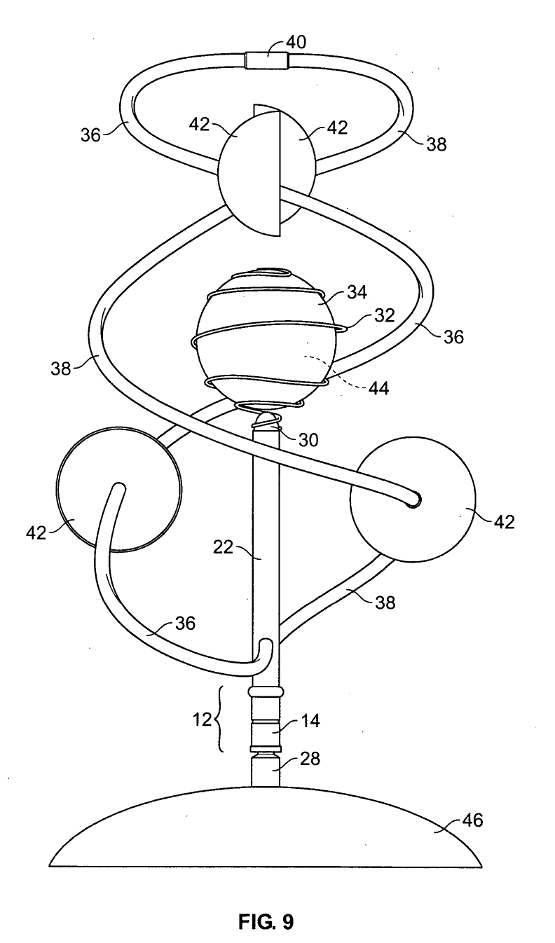

In another embodiment, shown in FIG. 9, the rotating sculpture 10 may be supported from the bottom, wherein the support element 12 would be attached to a suitable base 46. In such an embodiment, the rotatable coupling cylinder 14 may also be inverted so that the rotatable coupling fitting 24 (see FIG. 8) is now attached to the base 10, and central shaft 22 is attached to the rotatable coupling cylinder 14 in place of the top piece 16, so that the rotatable coupling 20 is shielded from water intrusion. In another embodiment using a base 46 (not shown), the rotating sculpture 10 is not inverted, but rather the base 46 may have a support member that runs through a decorative element 34 and central shaft 22, to the rotatable coupling 20 at the top of the rotating sculpture 10.

Although the embodiments herein have focused on a central element 22 with a substantially vertical orientation, the rotating sculpture 10 could be oriented at any angle. If the primary orientation is such that the central element 22 is horizontal, however, it may be desirable to relocate the rotatable coupling 20 more towards to the center of the rotating sculpture 10 so that the rotatable coupling 20 is more evenly loaded and will operate with greater efficiency. In such an embodiment, more than one rotatable coupling may be used at different locations along the central element 22 to evenly distribute the weight on each coupling 20. Also in such an embodiment, a radial bearing rather than a thrust bearing may be used to account for the radial loading, or a bearing that can take both axial and radial loading may be used. Such designs are well within the abilities of a person of ordinary skill in the art.

In closing, it is to be understood that the exemplary embodiments described herein are illustrative of the principles of the present invention. Other modifications that may be employed are within the scope of the invention. Thus, by way of example, but not of limitation, alternative configurations may be utilized in accordance with the teachings herein. Accordingly, the drawings and description are illustrative and not meant to be a limitation thereof.

What is claimed is:

1. A rotating sculpture, comprising:
at least one support element,
at least one central element rotatably coupled with at least one support element,
at least one decorative element,
at least one arm that is coupled with the central element and encircles some portion of the central element in a substantially spiral orientation, and
at least two wind cups coupled with at least one arm, in any number on said arm(s),
wherein at least one wind cup is oriented such that it catches existing air currents and exerts force on the arm with which it is coupled, which causes the central element with which the arm is coupled to rotate about its long axis.

2. The rotating sculpture of claim 1, further comprising
at least one illuminative element selected from the group consisting of household electricity powered light, battery powered electric light, solar powered electric light, wind-generated electric light, prismatic lenses, or reflective surfaces.

3. The rotating sculpture of claim 1 wherein at least one central element and at least one arm are constructed of metallic tubing.

4. The rotating sculpture of claim 1 wherein at least one wind cup is substantially hemispherical.

5. The rotating sculpture of claim 1 wherein there are two arms coupled with the central element, forming spirals that extend away from the support element, each spiral out of phase relative to the other spiral, wherein the arms are coupled with each other at a point distal to the support element and beyond at least one central element, and generally in line with the long axis of at least one central element.

6. The rotating sculpture of claim 5 wherein each of the two arms is coupled with at least one wind cup.

7. A rotating sculpture, comprising:
a support element,
a central element with two ends, the first end rotatably coupled with the support element,
at least one decorative element coupled with the central element approximately at its second end, said decorative elements having
at least one illuminative element selected from the group consisting of household electricity powered light, battery powered electric light, solar powered electric light, wind-generated electric light, prismatic lenses, or reflective surfaces,
at least one arm coupled with the central element, said arm extending generally away from the long axis of the central element, said arm then generally forming a spiral, the center of whose radius is approximately in line with the long axis of the central element, and the arm spirals in a direction generally along the long axis of the central element and away from the support element,
at least two wind cups,
wherein said arms are coupled with one or more wind cups, at least two wind cups are oriented such that they catch air currents and exert force on the arm with which they are coupled, which causes the central element with which said arm is coupled to rotate about its long axis via the rotatable coupling.

8. The rotating sculpture of claim 7, comprising at least two arms, wherein at a point distal to the decorative element, at least two of the arms substantially meet.

9. The rotating sculpture of claim 8, wherein the substantially meeting arms are coupled with each other.
